(19) United States
(12) Patent Application Publication
(10) Pub. No.: US 2007/0010617 A1
(43) Pub. Date: Jan. 11, 2007

(54) Aqueous dispersion for nail enamel and aqueous nail enamel composition

(76) Inventors: Takashi Ishikawa, Tokyo (JP); Kunihiro Inui, Tokyo (JP); Koji Ishii, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 10/574,550

(22) PCT Filed: Oct. 1, 2004
(86) PCT No.: PCT/JP04/14481

§ 371 Date: Apr. 3, 2006

(30) Foreign Application Priority Data
Oct. 10, 2003 (JP) 2003-343193

(51) Int. Cl. C08L 31/00

(52) U.S. Cl. 524/556; 524/700

(57) ABSTRACT

Provided is an aqueous dispersion for nail enamel comprising a copolymer (E) having a weight-average molecular weight as determined by GPC of 1×10⁴ to 4×10⁴ as polystyrene, being obtainable by polymerizing a total of 100 wt parts a monomer (A) selected from tert-butyl(meth)acrylate, cyclohexyl (meth)acrylate and benzyl(meth)acrylate and another radical-polymerization unsaturated monomer (B) in an aqueous medium in the presence of 0.1 to 10.0 wt parts of a compound (HS—CH₂—CH₂—COO)ₙ—R.

### TECHNICAL FIELD

The present invention relates to an aqueous dispersion for nail enamels and an aqueous nail enamel composition containing the aqueous dispersion.

### BACKGROUND ART

Nail enamels have been used widely as the cosmetics for the nail. Solvent-based nail enamels containing an organic solvent such as toluene or an acetic ester have been used mainly as nail enamels.

However, in a recent trend for higher safety, aqueous nail enamels that contain no organic solvent have been studied.

In aqueous nail enamels, it is not possible to use a material that forms a strong coated film and yet easily soluble in solvents like polish remover, such as nitrocellulose contained in conventional solvent-based nail enamels. Thus, there exists a need for development of an aqueous nail enamel that has properties, such as adhesiveness, coated film strength, glossiness, and removal efficiency, similar to those of the solvent-based nail enamels, without use of the materials that are contained in conventional solvent-based nail enamels. The removal efficiency is the efficiency of removing nail enamel with a nail remover.

There were many compositions studied for securing such film properties. For example, a resin composition in combination of a water-soluble resin and a resin dispersion was proposed.

Japanese Patent Application Laid-Open No. 11-269041 discloses an aqueous nail enamel of an emulsion containing an acrylic resin having a weight-average molecular weight of 50,000 or more and 80,000 or less and a glass transition temperature of 50° C. or higher and 80° C. or lower as its principal component.

Alternatively, Japanese Patent Application Laid-Open No. 7-69833 discloses an aqueous nail enamel of an aqueous polymer emulsion containing a polymer having a weight-average molecular weight of 40,000 or less and a polymer having a weight-average molecular weight of 50,000 or more in a total amount of 5 to 60 wt % as solid matter.

These aqueous nail enamels of a resin composition containing a water-soluble resin and a resin dispersion are superior in mechanical physical properties such as glossiness and hardness. However, these enamels, which contain a water-soluble resin having a high acid value, are less easily removed by enamel removers such as acetone. In addition, the coated film formed with an aqueous nail enamel is dissolved under a weakly alkaline environment that is encountered in daily life. Accordingly, there arises problems of significant deterioration in its strength and loss of the practicality as nail enamel.

As described above, the aqueous nail enamel disclosed in Japanese Patent Application Laid-Open No. 11-269041 has a relatively high molecular weight and a relatively high glass transition temperature, giving the coated film excellent durability. However, its higher weight-average molecular weight leads to lower solubility in solvents, and it is difficult to remove a coated film with a remover containing a smaller amount of organic solvent.

Further, as described above, the aqueous nail enamel disclosed in Japanese Patent Application Laid-Open No. 7-69833 contains both a low-molecular weight compound and a high-molecular weight compound, and thus, shows properties of both of them. Thus, it is possible to show the removal efficiency derived from the low-molecular weight compound and the mechanical physical properties derived from the high-molecular weight compound to some extent. However, presence of a high-molecular weight compound in the system results in decrease in the solubility insolvent. Accordingly, there it has been a problem that the coated film is not easily removed with a remover containing a smaller amount of organic solvent.

It is known to be very effective to raise the solubility in solvents by reducing the weight-average molecular weight of resin, generally for improvement in the removal efficiency.

However, reduction in molecular weight results in improvement in the solubility in solvents, but also in drastic deterioration in mechanical physical properties. Nail enamels used as a coated film on the nail demand the mechanical physical properties at the daily-life level. Deterioration in the mechanical physical properties of a nail enamel results in deterioration in the durability of the coated film. Thus, the improvements in removal efficiency and in mechanical physical properties are completely antinomic requirements. Thus, it was difficult to satisfy both of the requirements at the same time.

### DISCLOSURE OF THE INVENTION

In an embodiment, an object of the present invention is to provide an aqueous nail enamel satisfying the requirement in the balance between the removal efficiency and the mechanical physical properties at a higher level.

After intensive studies under the circumstances above, the inventors have found that a copolymer containing a particular monomer as its essential component was superior in mechanical physical properties even though it has a relatively low-molecular weight, and completed the present invention.

A feature of the present invention relates to an aqueous dispersion for nail enamel comprising a copolymer (E) having a weight-average molecular weight, as determined by gel-permeation chromatography, of 10,000 or more and 40,000 or less as polystyrene, which is obtainable by polymerizing a total of 100 wt parts of a monomer (A) selected from the group consisting of tert-butyl(meth)acrylate, cyclohexyl(meth)acrylate and benzyl(meth)acrylate and a radical-polymerization unsaturated monomer (B) other than the monomer (A) in an aqueous medium in the presence of 0.1 to 10.0 wt parts of a mercaptopropionic acid derivative (C) represented by the following General Formula (1):
(HS—CH₂—CH₂—COO)ₙ—R, General Formula (1)

wherein, R represents an alkyl group having 4 or more carbon atoms or an alkoxyalkyl group having 4 or more carbon atoms when n is 1 and an n-valent organic residue when n is 2 to 4.

The polymerization is preferably emulsion polymerization by using an anionic emulsifier (F) having one or more unsaturated radical-polymerization groups.

The monomer (A) is preferably contained in an amount of 1 to 50 wt % with respect to 100 wt % of the total of the monomer (A) and the radical-polymerization unsaturated monomer (B) other than the monomer (A).

The glass transition temperature (Tg) of the copolymer (E) is preferably 50 to 80° C.

The mercaptopropionic acid derivative (C) is preferably octyl mercaptopropionate.

The average particle diameter of the copolymer (E) is preferably 30 to 100 nm.

Another feature of the present invention relates to a method of producing an aqueous dispersion for nail enamel comprising a copolymer (E) having a weight-average molecular weight, as determined by gel-permeation chromatography, of 10,900 or more and 40,000 or less as polystyrene, which comprises polymerizing a total of 100 wt parts of a monomer (A) selected from the group consisting of tert-butyl(meth)acrylate, cyclohexyl(meth)acrylate and benzyl(meth)acrylate and a radical-polymerization unsaturated monomer (B) other than the monomer (A) in an aqueous medium in the presence of 0.1 to 10.0 wt parts of a mercaptopropionic acid derivative (C) represented by the following General Formula (1):
(HS—CH₂—CH₂—COO)ₙ—R, General Formula (1)

wherein R represents an alkyl group having 4 or more carbon atoms or an alkoxyalkyl group having 4 or more carbon atoms when n is 1 and an n-valent organic residue when n is 2 to 4.

Yet another feature of the present invention relates to an aqueous nail enamel composition, comprising the copolymer (E) described in any one of the inventions above in an amount of 10 to 60 wt %.

The aqueous nail enamel composition preferably contains a lower alcohol having a boiling point of lower than 100° C. in an amount of 0.5 to 15 wt %.

Yet another feature of the present invention relates to an aqueous dispersion for nail enamel, wherein a copolymer (E) is dispersed in an aqueous phase, the copolymer (E) having a weight-average molecular weight of 10,000 or more and 40,000 or less, formed from a monomer (A) selected from the group consisting of tert-butyl(meth)acrylate, cyclohexyl (meth)acrylate and benzyl(meth)acrylate and a radical-polymerization unsaturated monomer (B) other than the monomer (A) as the constituent units, and having a mercaptopropionic acid derivative represented by the following Formula (I) at the terminal of the copolymer (E):
(HS—CH₂—CH₂—COO)ₙ—R, General Formula (1)

wherein, R represents an alkyl group having 4 or more carbon atoms or an alkoxyalkyl group having 4 or more carbon atoms when n is 1 and an n-valent organic residue when n is 2 to 4.

A mercaptopropionic acid derivative (C) is used as the chain-transfer agent during polymerization of the copolymer (E), and thus, the mercaptopropionic acid derivative (C) is bound to the terminal of the copolymer (E).

A feature of the present invention provides an aqueous nail enamel satisfying the requirement in the balance between the removal efficiency and the mechanical physical properties at a higher level. When an aqueous dispersion in an embodiment of the present invention is used as an aqueous nail enamel, the aqueous nail enamel shows a high removal efficiency that was impossible in the past, and, in particular, a high durability of the enamel, which is an important requirement for use in daily life at the same time.

Disclosure of the present specification relates to the subject described in the Japanese Patent Application No. 2003-343193 (filed on Oct. 10, 2003), and the disclosure of which is incorporated by reference herein.

### BEST MODE OF CARRYING OUT THE INVENTION

The aqueous dispersion of copolymer (E) according to the present invention contains a particular monomer, i.e., a monomer (A) selected from the group consisting of tert-butyl (meth)acrylate, cyclohexyl(meth)acrylate and benzyl (meth)acrylate, as its essential component. These monomers (A) may be used alone or in combination of two or more.

A copolymer having a low weight-average molecular weight has been considered not to satisfy the demanded mechanical properties at all in hot water or even at room temperature. However, in an embodiment of the present invention, the copolymer forms a coated film sufficient tight even in hot water when the side-chain substituent group of monomer (A) has a particular function.

Thus, because of its characteristic composition, the copolymer shows favorable mechanical physical properties and a removal efficiency at a level beyond comparison, even in an environment at room temperature or in hot water.

The aqueous dispersion of copolymer (E) according to the present invention can be prepared by emulsion polymerization of the monomer (A) and another radical-polymerization unsaturated monomer (B) other than the monomer (A) in an aqueous medium in the presence of a particular chain-transfer agent (C) described below.

The monomer (B) is one or more monomers selected from monomers known in the art such as acrylic acid, methacrylic acid or the alkyl esters or derivatives thereof and vinyl monomers. More specific examples of the monomers (B) include the following monomers, but are not limited thereto.

Ethylenic unsaturated carboxylic acids including (meth)acrylic acid, itaconic acid, fumaric acid, maleic acid, crotonic acid, and the like.

Aromatic vinyl compounds including styrene, α-methylstyrene, vinyltoluene, and the like.

Ethylenic unsaturated carboxylic alkylamides including aminoethylacrylamide, dimethylaminomethylmethacrylamide, methylaminopropylmethacrylamide, aminoalkylamide, (meta)acrylamide, N-methylolacrylamide, and the like. Ethylenic unsaturated carboxylic aminoalkylesters including aminoethyl acrylate, dimethylaminoethyl(meth)acrylate, diethylaminoethyl(meth)acrylate, butylaminoethyl acrylate, and the like.

Vinyl cyanide monomers including (meta)acrylonitrile, α-chloroacrylonitrile, and the like. Unsaturated aliphatic glycidyl esters including glycidyl(meth)acrylate, 3,4-epoxycyclohexylmethyl(meth)acrylate, glycidylvinylether, 3,4-epoxycyclohexylvinylether, glycidyl(meta) allylether, 3,4-epoxycyclohexyl(meta)allylether, and the like.

Hydroxyl group-containing carboxylic esters including hydroxyethyl(meth)acrylate, hydroxypropyl(meth)acrylate, hydroxybutyl(meth)acrylate, and the like.

Carboxylic vinylesters including methyl(meth)acrylate, ethyl(meth)acrylate, n-propyl(meth)acrylate, n-butyl (meth)acrylate, isobutyl(meth)acrylate, octyl(meth)acrylate, isooctyl(meth)acrylate, 2-ethylhexyl(meth)acrylate, lauryl (meth)acrylate, stearyl(meth)acrylate, isodecyl (meth)acrylate, tridecyl(meth)acrylate, alkylene glycol (meth)acrylate, tetrahydrofurfuryl(meth)acrylate, phenoxyethyl(meth)acrylate, isobonyl(meth)acrylate, and the like.

These monomers (B) may be used alone or in combination of two or more arbitrarily in an amount in the range that does not impair the physical properties of the copolymer.

The content of the monomer (A) is preferably 1 to 50 wt %, more preferably 5 to 15 wt %, with respect to the total monomers for use in polymerization, i.e., with respect to 100 wt % of the total of monomers (A) and (B), from the point of the mechanical physical properties of coated film in hot water.

The glass transition temperature (hereinafter, referred to also as Tg) of the copolymer (E) prepared by copolymerization of the monomers (A) and (B) is preferably 50 to 80° C. A copolymer having a Tg of lower than 50° C. leads to deterioration in the mechanical physical properties at room temperature. Alternatively, a copolymer having a Tg of higher than 80° C. leads to deterioration in the removal efficiency and strength of the coated film. A copolymer having a Tg in the range of 50 to 80° C. favorably further improves removal efficiency and the durability of enamel because of its mechanical physical properties at room temperature and in hot water when used in a nail enamel.

The glass transition temperature Tg of the copolymer (E) according to the present invention is calculated according to the following Formula:
1/Tg=(W₁/Tg₁)+(W₂/Tg₂)+ . . . (Wₙ/Tgₙ).

In the Formula,

W₁ represents the weight percentage of monomer 1 and Tg₁, the glass transition temperature Tg (K) of homopolymer of monomer 1;

W₂ represents the weight percentage of monomer 2 and Tg₂, the glass transition temperature Tg (K) of homopolymer of monomer 2; and

Wₙ represents the weight percentage of monomer n and Tgₙ, the glass transition temperature Tg (K) of homopolymer of monomer n.

Even if a compound containing an unsaturated radical-polymerization group as the emulsifier (F) is used during emulsion polymerization, the unsaturated radical-polymerization group-containing emulsifier is not included in the monomer (B) in calculation of the content of monomer (A) and the Tg of copolymer (E).

Hereinafter, the chain-transfer agent used in preparation of the aqueous dispersion of copolymer (E) according to the present invention will be described. The chain-transfer agent is used for regulation of molecular weight.

Generally among many chain-transfer agents, mercapto group (thiol group)-containing chain-transfer agents have an extremely unpleasant characteristic odor. For that reason, they are not usable at all in applications such as cosmetics.

However, mercaptopropionic acid derivatives (C) represented by the following General Formula (1) have no odor and are usable in cosmetics such as nail enamel:
(HS—CH₂—CH₂—COO)ₙ—R, General Formula (1)

wherein, R represent an alkyl group having 4 or more carbon atoms or an alkoxyalkyl group having 4 or more carbon atoms when n is 1; and R represents an n-valent organic residue when n is 2 to 4.

A chain-transfer agent other than the mercaptopropionic acid derivatives (C) may be used in an extremely small amount in the range that does not cause unpleasant odor.

In the present invention, the mercaptopropionic acid derivative (C) is used in the amount of 0.1 to 10.0 wt parts, preferably 0.5 to 5.0 wt parts, with respect to 100 wt parts of the total of the monomers (A) and (B). Use of a mercaptopropionic acid derivative (C) in an amount of less than 0.1 wt parts may lead to polymerization of the copolymer (E) to a weight-average molecular weight of more than 40,000 and thus, to drastic deterioration in the removal efficiency of coated film. On the other hand, use of a mercaptopropionic acid derivative (C) in an amount of more than 10.0 wt parts may lead to decrease in the weight-average molecular weight of copolymer (E) to less than 10,000 and to drastic decrease in the mechanical physical properties of coated film, even when the monomer (A) is used as the essential component.

The weight-average molecular weight of the copolymer (E) obtained is 10,000 to 40,000, preferably 15,000 to 25,000, considering the removal efficiency and mechanical physical properties at room temperature and in hot water.

All nail enamels including aqueous enamels contain a pigment for coloring and should satisfy the requirement in the color tone as coated film. Also demanded is appearance reproducibility that the color tone and texture before application on nail are not different from those of the coated film after drying.

Use of a mercaptopropionic acid derivative (C) in an amount of 0.1 to 10 wt parts with respect to 100 wt parts of the monomers allowed adjustment of the molecular weight of copolymer (E) and of the balance between the removal efficiency and mechanical physical properties of the resulting enamel. Accordingly, it became possible to provide a nail enamel superior in appearance reproducibility that has almost no change in color tone between before and after coating.

The appearance reproducibility as nail enamel is significantly associated with the transparency of the aqueous dispersion of copolymer (E), while the transparency of the aqueous dispersion with the dispersion state of the copolymer (E). Thus, the volume-average particle diameter of the copolymer (E) is preferably 30 to 100 nm and more preferably 40 to 90 nm. Presence of bulky particles having a diameter of more than 200 nm may result in drastic decrease in transparency. Thus, it is preferable to reduce the bulky particles of more than 200 nm in diameter to an amount of 5 vol % or less.

Presence of particles having a volume-average particle diameter of more than 100 nm may lead to slight deterioration in its appearance reproducibility, when a high appearance reproducibility is demanded for nail enamel. However, such particles may be used, depending on the degree of appearance reproducibility demanded.

In addition, particles having a volume-average diameter of smaller than 30 nm lead to increase in the viscosity of the dispersion itself. Thus, such particles may affect the storage stability as nail enamel and the efficiency of coating during use.

Among the mercaptopropionic acid derivatives (C) for use in the present invention, examples of those in which n is 1 include, but are not limited to, alkyl mercaptopropionates such as octyl mercaptopropionate, n-butyl 3-mercaptopropionate, and tridecyl mercaptopropionate; alkoxyalkyl mercaptopropionates such as methoxybutyl mercaptopropionate; and the like. The alkyl group in the alkyl mercaptopropionate may be a straight-chain or branched alkyl group. Favorable examples of the mercaptopropionic acid derivatives (C) include octyl mercaptopropionate; and n-octyl mercaptopropionate or 2-ethylhexyl mercaptopropionate may also be used, and both may be used in combination.

The derivative in which n is 2 to 4 is not particularly limited, but examples thereof include ethylene glycol bisthiopropionate, butanediol bisthiopropionate, trimethylolpropane tristhiopropionate, tris(2-hydroxyethyl)isocyanurate tris(β-mercaptopropionate), and the like.

In the present invention, these known derivatives may be used alone or in combination of two or more. Especially when monomers including the monomer (A) as essential component are polymerized with any one of these derivatives (C) in the presence of octyl mercaptopropionate, there is no problem of odor during use of the nail enamel. It also becomes possible to provide an aqueous dispersion of copolymer (E) having a molecular weight favorably adjusted. It is particularly preferable, because it is possible to control the dispersion particle diameter of copolymer (E), which influences significantly on the appearance during use as nail enamel, in a favorable range.

The aqueous dispersion of copolymer (E) according to the present invention is prepared by any one of known polymerization methods. In particular, an emulsion polymerization method, which allows easier control of the dispersion particle diameter and molecular weight of the copolymer (E) obtained, is particularly preferable.

In the present invention, any one of known emulsifiers, such as reactive emulsifiers having a radically polymerizable group in its structure and unreactive emulsifiers, may be used as the emulsifier for use in emulsion polymerization.

Examples of the reactive emulsifiers having a radically polymerizable group in the structure are roughly classified into two, anionic and nonionic emulsifiers. In particular, single use of an anionic reactive emulsifier (F) having one or more unsaturated radical-polymerization groups is preferable, because it leads to reduction in the dispersion particle diameter of copolymer (E) and narrower particle-size distribution and improves the appearance reproducibility during use as nail enamel more drastically. The anionic reactive emulsifiers having one or more unsaturated radical-polymerization groups may be used alone or in combination of two or more.

Typical examples of the anionic reactive emulsifiers (F) will be described below, but the anionic reactive emulsifiers for use in present invention are not limited thereto.

Alkylethers (examples of commercial products include Aqualon KH-05, KH-10, and KH-20 manufactured by Dai-ichi Kogyo Seiyaku Co., Ltd., Adeka Reasoap SR-10 and SR-20 manufactured by Asahi Denka Co., Ltd., Latemul PD-104 manufactured by Kao Corp., and the like) and sulfosuccinic esters (examples of commercial products include Latemul S-120, S-120A, S-180P, and S-180A manufactured by Kao Corp. and Eleminol JS-2 manufactured by Sanyo Chemical Industries, Ltd. and the like).

Alkylphenylethers or alkylphenylesters (examples of commercial products include Aqualon H-2855A, H-3855B, H-3855C, H-3856, HS-05, HS-10, HS-20, and HS-30 manufactured by Dai-ichi Kogyo Seiyaku Co., Ltd., Adeka Reasoap SDX-222, SDX-223, SDX-232, SDX-233, SDX-259, SE-10N, SE-20N, and SE-1025A manufactured by Asahi Denka Co., Ltd., and others).

(Meth)acrylate sulfate esters (examples of commercial products include Antox MS-60 and MS-2N manufactured by Nippon Nyukazai Co., Ltd., Eleminol RS-30 manufactured by Sanyo Chemical Industries Co., Ltd., and others) and phosphoric acid esters (examples of commercial products include H-3330PL manufactured by Dai-ichi Kogyo Seiyaku Co., Ltd., Adeka Reasoap PP-70 manufactured by Asahi Denka Co., Ltd. and others).

The nonionic reactive emulsifier may be used alone or in combination with the anionic reactive emulsifier above as needed in preparation of the aqueous dispersion of copolymer (E) according to the present invention by emulsion polymerization. The nonionic reactive emulsifiers for use in the present invention include those below, but are not limited thereto.

Commercial products of nonionic reactive emulsifier alkylethers include Adeka Reasoap ER-10, ER-20, ER-30, and ER-40 manufactured by Asahi Denka Co., Ltd. and Latemul PD-420, PD-430, and PD-450 manufactured by Kao Corp.

Commercial products of alkylphenylethers or alkylphenylesters include Aqualon RN-10, RN-20, RN-30, and RN-50 manufactured by Dai-ichi Kogyo Seiyaku Co., Ltd. and Adeka Reasoap NE-10, NE-20, NE-30, and NE-40 manufactured by Asahi Denka Co., Ltd.

Commercial products of (meth)acrylate sulfate esters include RMA-564, RMA-568 and RMA-1114 manufactured by Nippon Nyukazai Co., Ltd.

In preparation of the aqueous dispersion of copolymer (E) according to the present invention by emulsion polymerization, an unreactive emulsifier may be used in combination with the radically polymerizable group-containing reactive emulsifier above in the range that does not impair the properties of the aqueous dispersion obtained.

The unreactive emulsifiers are roughly classified into two groups: unreactive anionic and nonionic emulsifiers.

Examples of the unreactive nonionic emulsifiers include polyoxyethylene alkylethers such as polyoxyethylene laurylether and polyoxyethylene stearylether, polyoxyethylene alkylphenylethers such as polyoxyethylene octylphenylether and polyoxyethylene nonylphenylether, sorbitan higher fatty esters such as sorbitan monolaurate, sorbitan monostearate, sorbitan trioleate, polyoxyethylene sorbitan higher fatty esters such as polyoxyethylene sorbitan monolaurate, polyoxyethylene higher fatty esters such as polyoxyethylene monolaurate and polyoxyethylene monostearate, glycerol higher fatty esters such as oleic acid monoglyceride and stearic acid monoglyceride, polyoxyethylene-polyoxypropylene block copolymer, and the like, as well as polyoxyethylene distyrenated phenylether and the like.

Examples of the unreactive anionic emulsifiers include higher fatty acid salts such as sodium oleate, alkyl arylsulfonate salts such as sodium dodecylbenzenesulfonate, alkylsulfate ester salts such as sodium laurylsulfate, polyoxyethylene alkylether sulfate ester salts such as sodium polyoxyethylene laurylether sulfate, polyoxyethylene alkylarylether sulfate ester salts such as sodium polyoxyethylene nonylphenylether sulfate, alkyl sulfosuccinic acid ester salts such as sodium monooctylsulfosuccinate, sodium dioctylsulfosuccinate, and sodium polyoxyethylene laurylsulfosuccinate, the derivatives thereof, and the like. Also included are polyoxyethylene distyrenated phenylether sulfate ester salts.

The amount of the emulsifier used in the present invention is not particularly limited. The emulsifier is selected properly according to the physical properties demanded during use of the copolymer (E) in the final aqueous nail enamel. For example, the amount of the emulsifier (F) used is normally, preferably in the range of 0.1 to 30 wt parts, more preferably 0.3 to 20 wt parts, and still more preferably 0.5 to 10 wt parts, with respect to 100 wt parts of the total of the monomers (A) and (B) used in polymerization.

In emulsion polymerization of the copolymer (E) according to the present invention, a water-soluble protective colloid may be used additionally for improvement in the affinity to aqueous medium in the range that does not impair the properties of the aqueous dispersion of copolymer (E) obtained.

Examples of the water-soluble protective colloids include, but are not limited to, polyvinylalcohols such as partially saponified polyvinylalcohols, completely saponified polyvinylalcohol, and modified polyvinylalcohols; cellulose derivatives such as hydroxyethylcellulose, hydroxypropylcellulose, and carboxymethylcellulose salts; and natural polysaccharides such as gua gum; and the like, and these colloids may be used alone or in combination of two or more.

The amount of the water-soluble protective colloid used is preferably approximately 0.1 to 5 wt parts, more preferably 0.5 to 2 wt parts, with respect to 100 wt parts of the total of radical-polymerization unsaturated monomers.

The aqueous medium used in the emulsion polymerization of the copolymer (E) according to the present invention is, for example, water. A hydrophilic organic solvent may be used additionally in the range that does not impair the object of the present invention.

The polymerization initiator for use in preparation of the aqueous dispersion of copolymer (E) according to the present invention is not particularly limited, if it is an oil-soluble or water-soluble polymerization initiator and it has an action to initiate radical polymerization.

The oil-soluble polymerization initiator is not particularly limited, and examples thereof include organic peroxides such as benzoyl peroxide, tert-butyl peroxybenzoate, ter-butyl hydroperoxide, tert-butyl peroxy(2-ethylhexanoate), tert-butyl peroxy-3,5,5-trimethylhexanoate, and di-tert-butyl peroxide; azobis compounds such as 2,2′-azobisisobutylonitrile, 2,2′-azobis-2,4-dimethylvaleronitrile, 2,2′-azobis(4-methoxy-2,4-dimethylvaleronitrile), 1,1′-azobis-cyclohexane-1-carbonitrile, 2,2′ azobis(2-methylbutylonitrile), dimethyl-2,2′-azobis(2-methyl propionate), 2,2′-azobis[N-(2-propenyl)-2-methylpropionamide]; and the like. These polymerization inhibitors may be used alone or in combination of two or more. The polymerization initiator is used in an amount of approximately 0.1 to 10.0 wt parts with respect to 100 wt parts of the total of radical-polymerization unsaturated monomers.

A water-soluble polymerization initiator is preferably used in the present invention. Favorable examples of the polymerization initiators include, but are not limited to, known initiators such as ammonium persulfate, potassium persulfate, 1-[(1-cyano-1-methylethyl)azo]formamide, 2,2′-azobis{2-methyl-N-[2-(1-hydroxybutyl)]propionamide}, 2,2′-azobis{2-[2-imidazolin-2-yl]propane}disulfate dehydrate, 2,2′-azobis(2-[1-(2-hydroxyethyl)-2-imidazolin-2-yl]propane)dihydrochloride, 2,2′-azobis[2-(2-imidazolin-2-yl)propane], 2,2′-azobis(1-imino-1-pyrrolidino-2-methylpropane) dihydrochloride, 2,2′-azobis(2-methylpropionamidine) dihydrochloride, and 2,2′-azobis[N-(2-carboxyethyl)-2-methylpropionamidine]tetrahydrate. A reducing agent may also be used together with the polymerization initiator as needed in emulsion polymerization. Addition thereof accelerates emulsification polymerization and makes the emulsion polymerization proceed easier at lower temperature. Examples of such reducing agents include, but are not limited to, reductive organic compounds such as ascorbic acid, tartaric acid, citric acid, glucose, and metal salts of formaldehyde sulfoxylate; reductive inorganic compounds such as sodium thiosulfate, sodium sulfite, sodium bisulfite, and sodium metabisulfite; ferrous chloride, Rongalite, thiourea dioxide, and the like. The reducing agent is preferably used in an amount of approximately 0.05 to 5.0 wt parts with respect to 100 wt parts of the total of radical-polymerization unsaturated monomers.

Polymerization may be conducted, for example, in a photochemical reaction or by radioactive ray irradiation, instead of using the polymerization initiator.

The polymerization temperature is not lower than the polymerization initiation temperature of each polymerization initiator. For example, it is normally approximately 70° C. for peroxide polymerization initiators. The polymerization period is not particularly limited, but normally 2 to 24 hours.

Hereinafter, the aqueous nail enamel composition according to the present invention will be described.

The aqueous nail enamel composition according to the present invention preferably contains the copolymer (E) above in an amount of 10 to 60 wt % and more preferably 20 to 50 wt %. That is, the copolymer (E) is preferably contained as solid matter in an amount of 10 to 60 wt % in the aqueous dispersion of the aqueous resin dispersion (E) containing various additives.

The aqueous nail enamel composition according to the present invention can be used favorably in applications of various nail enamels such as nail enamel topcoat and nail enamel basecoat.

The aqueous nail enamel composition according to the present invention may contain various ingredients commonly used in the art such as crosslinking agent, filming aid, plasticizer, colorant (pigment, dye, or colorant), and viscosity adjustor (gelling agent).

In addition, the aqueous nail enamel composition according to the present invention may contain additionally as needed, an emulsifier for pigment dispersion, polymer dispersant, resin dispersion other than those above, resin, water-soluble polymer, antiseptic, antifoam, antioxidant, flavoring agent, ultraviolet absorbent, cosmetic ingredient, thickener, leveling agent, wetting agent, dispersant, preservative, UV screening agent, moisturizer, flavoring agent, neutralizer, stabilizer, or the like.

The crosslinking agents to be blended in the aqueous nail enamel composition according to the present invention include compounds having an alkoxysilane group having 1 to 14 carbons. The aqueous nail enamel composition according to the present invention has superior properties, even if it does not contain the alkoxysilane group-containing compound. However, addition of the alkoxysilane group-containing compound is effective in providing the resulting coated film with superior water resistance, stability in glossiness, resistance to temperature fluctuation, and other.

The alkoxysilane group-containing compound is not particularly limited if it has one or more alkoxysilane groups containing an alkoxyl group having 1 to 14 carbon atoms, and the alkoxyl group having 1 to 14 carbons may be a straight-chain or branched alkoxy group. In addition, one to four alkoxyl groups may be bound to the silicon atom constituting the alkoxysilane group.

The alkoxysilane group-containing compound is not particularly limited, and examples thereof include tetramethoxysilane, trimethoxymethylsilane, dimethoxydimethylsilane, methoxytrimethylsilane, tetraethoxysilane, triethoxylethylsilane, diethoxydiethylsilane, ethoxytriethylsilane, γ-glycidoxypropyltrimethoxysilane, γ-aminopropyltrimethoxysilane, vinyltrimethoxysilane, vinyltriethoxysilane, vinyltris(β-methoxyethoxy)silane, vinylmethyldimethoxysilane, γ-methacryloxypropyltrimethoxysilane, γ-methacryloxypropylmethyldimethoxysilane, γ-methacryloxypropyltriethoxysilane, γ-methacryloxypropylmethyldiethoxysilane, γ-acryloxypropyltrimethoxysilane, γ-acryloxypropylmethyldimethoxysilane, γ-glycidoxypropyltrimethoxysilane, β-(3,4-epoxycyclohexyl)ethyltrimethoxysilane, γ-mercaptopropyltrimethoxysilane, γ-aminopropyltrimethoxysilane, N-(β-aminoethyl)-γ-aminopropyltrimethoxysilane, cyclohexylmethyldimethoxysilane, cyclohexyltrimethoxysilane, cyclopentyltrimethoxysilane, vinyltriethoxysilane, γ-methacryloxypropyltrimethoxysilane, and the like. These compounds may be used alone or in combination of two or more. Among them, tetramethoxysilane, trimethoxymethylsilane, dimethoxydimethylsilane, methoxytrimethylsilane, and γ-glycidoxypropyltrimethoxysilane are particularly preferable.

The alkoxysilane group-containing compound may be present in an amount of 0.1 to 10 wt % with respect to 100 wt parts of the nail enamel according to the present invention. An amount of the alkoxysilane group-containing compound of less than 0.1 wt % may result in insufficient addition effect, due to insufficient crosslinking or polymerization based on the siloxane bonds, while an amount of more than 10 wt % may result in instabilization of polymerization. The amount is preferably, 0.5 to 8 wt % and more preferably 1 to 7 wt %.

The filming aid to be blended in the aqueous nail enamel composition according to the present invention makes coat-film formation easier and, after formation of the coated film, vaporizes relatively rapidly, showing a temporary plasticizing function to improve the strength of the coated film. A solvent having a boiling point of 110 to 220° C. is used favorably as such a filming aid.

Typical examples thereof include, but are not limited to, propylene glycol monobutylether, ethylene glycol methylether, ethylene glycol ethylether, ethylene glycol monobutylether, carbitol, butylcarbitol, dibutylcarbitol, benzylalcohol, dipropylene glycol monopropylether, and the like. Among them, ethylene glycol monobutylether, propylene glycol monobutylether, and dipropylene glycol monopropylether are particularly preferably, because they are effective in film forming in a small amount and have a smaller influence on the properties of the product such as drying speed and water resistance. The filming aid is preferably contained in an amount of 0.5 to 15 wt % with respect to 100 wt parts of the aqueous nail enamel.

A known plasticizer may be added to the aqueous nail enamel composition according to the present invention, for improvement in the film-forming property, removal efficiency, and mechanical physical properties of coated film.

Examples of the plasticizers include, but are not limited to, diisobutyl adipate, tert-butyric 2,2,4-trimethylpentane-1,3-diol ester, diethyl adipate, diethyl phthalate, dibutyl phthalate, dioctyl phthalate, butyl-2-ethylhexyl phthalate, dimethyl sebacate, diethyl sebacate, diisopropyl sebacate, dibutyl sebacate, ethyl stearate, 2-ethylhexyl palmitate, dipropylene glycol n-butylether and the mixtures thereof.

The plasticizer preferably has a boiling point, as determined under atmospheric pressure, of 285° C. or lower, more preferably 270° C. or lower, and still more preferably 250° C. or lower.

In the present invention, the boiling point has a range of ±2° C., considering measurement error and others.

An antifreezing agent may be added to the aqueous nail enamel composition according to the present invention for prevention of freezing and solidification. The antifreezing agent is preferably a compound that vaporizes relatively rapidly after formation of coated film and shows smaller influence on the physical properties of the coated film, and favorable examples include lower alcohols having a boiling point of less than 100° C.

Typical examples of such lower alcohols include, but are not limited to, methanol, ethanol, n-propanol, isopropanol, sec-butanol, and tert-butanol. Among them, ethanol is preferable, considering the influence on the body and nail. The antifreezing agent is preferably contained in an amount of 0.5 to 15 wt % with respect to 100 wt % of the aqueous nail enamel composition.

Any one of known viscosity adjustors (gelling agents) may be added to the aqueous nail enamel composition according to the present invention for prevention of separation and precipitation. The viscosity adjustor is not particularly limited, and may be selected, for example, from bentonite, hectolite, montmorillonite, smectite, magnesium silicate, aluminum magnesium silicate, sodium magnesium silicate, silica and the mixtures thereof.

Hereinafter, advantageous effects of the present invention will be described with reference to Examples, but it should be understood that the present invention is not restricted thereby.

Aqueous copolymer dispersions were prepared in Examples 1 to 12 and Comparative Examples 1 to 6, and then, a nail enamel was prepared by using each of the aqueous dispersions obtained and evaluated in the following evaluation tests. The results are summarized in Table.

### EXAMPLE 1

265.0 wt parts of ion-exchange water and 5.9 wt parts of an anionic reactive emulsifier Aqualon KH-10 (manufactured by Dai-ichi Kogyo Seiyaku) were placed in a reaction container equipped with a stirrer, a thermometer, a dropping funnel, and a reflux condenser.

39.3 wt parts of tert-butyl methacrylate as the monomer (A), 235.6 wt parts of methyl methacrylate, 39.3 wt parts of styrene, 3.9 wt parts of acrylic acid, 70.7 wt parts of 2-ethylhexyl acrylate and 3.9 wt parts of 2-hydroxyethyl methacrylate as the other radical-polymerization unsaturated monomers (B), 7.8 wt parts of a chain-transfer agent 2-ethylhexyl-3-mercaptopropionate as the mercaptopropionic acid derivative (C), 263.7 wt parts of ion-exchange water, and 5.9 wt parts of Aqualon KH-10 (manufactured by Dai-ichi Kogyo Seiyaku) as the anionic reactive emulsifier were mixed, to give a preemulsion. 5% of the preemulsion obtained was added into the reaction container above.

The reaction container was heated to an internal temperature of 60° C. and substituted sufficiently with nitrogen, and 6.0 wt parts of a water-soluble polymerization initiator 5% aqueous solution of potassium persulfate and 14.7 wt parts of a reducing agent 1% aqueous solution of sodium metabisulfite were added thereto to initiate polymerization.

After the reaction container was kept at an internal temperature of 70° C. for 5 minutes, and the other preemulsion, 9.8 wt parts of 5% aqueous solution of potassium persulfate, and 24.6 wt parts of 1% aqueous solution of sodium metabisulfite were added dropwise over 3 hours, and the resulting mixture was stirred additionally for 3 hours while agitated at an internal temperature kept at 70° C. The pH of the polymerization reaction solution was kept at 3.0 during the emulsion polymerization. After reaction, the solution was cooled to a temperature of 30° C.; 3.9 wt parts of 25% aqueous ammonia was added until the pH of the solution became 8.5, to give an aqueous dispersion having a nonvolatile matter concentration of 40.5 wt %. The nonvolatile matter concentration was determined by the amount of residue after the dispersion was baked at 150° C. for 20 minutes.

The weight-average molecular weight of the copolymer in the aqueous dispersion obtained, as determined by gel-permeation chromatography, was 20,000 as polystyrene. The copolymer in the aqueous dispersion was analyzed, after it is collected by filtration, dried, and redissolved in tetrahydrofuran.

The glass transition temperature (calculated) of the copolymer in the aqueous dispersion obtained was 60° C.

The average particle diameter of the particles dispersed in the aqueous dispersion obtained was 60 nm. The average particle diameter was determined by using a dynamic light-scattering particle diameter distribution analyzer.

Then, a pigment dispersion paste was prepared. In preparation of the pigment dispersion paste, 2.0 wt parts of an acrylic copolymer (polymer dispersion, trade name “Johncryl J-68” manufactured by Johnson Polymer Inc., styrene-acrylic acid copolymer, weight-average molecular weight: 10,000, nonvolatile matter content: 100 wt %), 77.5 wt parts of ion-exchange water, and 0.5 wt part of 25% aqueous ammonia (neutralizer) were mixed and stirred; 20.0 wt parts of titanium oxide (pigment) was added to the aqueous solution obtained, to give a crude dispersion; 100 wt parts of glass beads (diameter: 0.5 mm) were added thereto; and the mixture was wet-pulverized and dispersed in a bead mill-dispersing machine for 1 hour. A pigment dispersion paste was obtained after removal of bulky particles and dusts by filtration of the dispersion through a membrane filter having an opening of 5 μm.

Three wt parts of the pigment dispersion paste obtained, 87.5 wt parts of the aqueous dispersion obtained, plasticizers of 3 wt parts of diethyl sebacate and 6 wt parts of propylene glycol monobutylether, and 2 wt parts of mica were mixed, to give an aqueous nail enamel composition; and the basic properties and practical physical properties thereof were evaluated according to the methods and criteria described below.

### EXAMPLE 2

An aqueous dispersion was prepared in a similar manner to Example 1, except that 7.8 wt parts of 2-ethylhexyl-3-mercaptopropionate, the mercaptopropionic acid derivative used as the chain-transfer agent, (C) was replaced with 5.0 wt parts of methoxybutyl mercaptopropionate. The nonvolatile matter concentration of the aqueous dispersion was 40.1 wt %.

The weight-average molecular weight of the copolymer in the aqueous dispersion obtained, as determined by gel-permeation chromatography, was 30,000 as polystyrene. The glass transition temperature (calculated) of the copolymer in the aqueous dispersion obtained was 60° C. The average particle diameter of the particles dispersed in the aqueous dispersion obtained was 110 nm.

A nail enamel composition was prepared and evaluated hereinafter, in a similar manner to the Example above.

### EXAMPLE 3

An aqueous dispersion was prepared in a similar manner to Example 1, except that 235.6 wt parts of methyl methacrylate was changed to 196.3 wt parts and 70.7 wt parts of 2-ethylhexyl acrylate to 110.0 wt parts. The nonvolatile matter concentration of the aqueous dispersion was 40.4 wt %.

The weight-average molecular weight of the copolymer in the aqueous dispersion obtained, as determined by gel-permeation chromatography, was 23,000 as polystyrene. The glass transition temperature (calculated) of the copolymer in the aqueous dispersion obtained was 40° C. The average particle diameter of the particles dispersed in the aqueous dispersion obtained was 70 nm.

A nail enamel composition was prepared and evaluated hereinafter, in a similar manner to the Example above.

### EXAMPLE 4

An aqueous dispersion was prepared in a similar manner to Example 1, except that 5.9 wt parts of Aqualon KH-10 (manufactured by Dai-ichi Kogyo Seiyaku) added twice in Example 1 was changed to mixture of 3.0 wt parts of Aqualon KH-10 (manufactured by Dai-ichi Kogyo Seiyaku) and 2.9 wt parts of a nonionic reactive emulsifier Adeka Reasoap ER-20 (manufactured by Asahi Denka) respectively. The nonvolatile matter concentration of the aqueous dispersion was 40.6 wt %.

The weight-average molecular weight of the copolymer in the aqueous dispersion obtained, as determined by gel-permeation chromatography, was 20,000 as polystyrene. The glass transition temperature (calculated) of the copolymer in the aqueous dispersion obtained was 55° C. The average particle diameter of the particles dispersed in the aqueous dispersion obtained was 70 nm.

A nail enamel composition was prepared and evaluated hereinafter, in a similar manner to the Example 1 above.

### EXAMPLE 5

An aqueous dispersion was prepared in a similar manner to Example 1, except that 39.3 wt parts of tert-butylmethacrylate was changed to 117.8 wt parts, 235.6 wt parts of methyl methacrylate to 164.9 wt parts, and 70.7 wt parts of 2-ethylhexyl acrylate to 62.8 wt parts. The nonvolatile matter concentration of the aqueous dispersion was 40.5 wt %.

The weight-average molecular weight of the copolymer in the aqueous dispersion obtained, as determined by gel-permeation chromatography, was 20,000 as polystyrene. The glass transition temperature (calculated) of the copolymer in the aqueous dispersion obtained was 65° C. The average particle diameter of the particles dispersed in the aqueous dispersion obtained was 60 nm.

A nail enamel composition was prepared and evaluated hereinafter, in a similar manner to the Example above.

### EXAMPLE 6

An aqueous dispersion was prepared in a similar manner to Example 1, except that 39.3 wt parts of tert-butylmethacrylate was changed to 19.7 wt parts of tert-butyl methacrylate and 19.6 wt parts of cyclohexyl methacrylate, 235.6 wt parts of methyl methacrylate to 238.4 wt parts, and 70.7 wt parts of 2-ethylhexyl acrylate to 67.9 wt parts. The nonvolatile matter concentration of the aqueous dispersion was 40.5 wt %.

The weight-average molecular weight of the copolymer in the aqueous dispersion obtained, as determined by gel-permeation chromatography, was 20,000 as polystyrene. The glass transition temperature (calculated) of the copolymer in the aqueous dispersion obtained was 60° C. The average particle diameter of the particles dispersed in the aqueous dispersion obtained was 60 nm.

A nail enamel composition was prepared and evaluated hereinafter, in a similar manner to the Example above.

### EXAMPLE 7

An aqueous dispersion was prepared in a similar manner to Example 1, except that 39.3 wt parts of tert-butylmethacrylate was change to 39.3 wt parts of benzyl methacrylate, 235.6 wt parts of methyl methacrylate to 244.3 wt parts, and 70.7 wt parts of 2-ethylhexyl acrylate to 62.0 wt parts. The nonvolatile matter concentration of the aqueous dispersion was 40.3 wt %.

The weight-average molecular weight of the copolymer in the aqueous dispersion obtained, as determined by gel-permeation chromatography, was 20,000 as polystyrene. The glass transition temperature (calculated) of the copolymer in the aqueous dispersion obtained was 60° C. The average particle diameter of the particles dispersed in the aqueous dispersion obtained was 60 nm.

A nail enamel composition was prepared and evaluated hereinafter, in a similar manner to the Example above.

### EXAMPLE 8

An aqueous dispersion was prepared in a similar manner to Example 1, except that 39.3 wt parts of tert-butylmethacrylate was changed to 39.3 wt parts of cyclohexyl methacrylate, 235.6 wt parts of methyl methacrylate to 242.3 wt parts, and 70.7 wt parts of 2-ethylhexyl acrylate to 64.0 wt parts. The nonvolatile matter concentration of the aqueous dispersion was 40.2 wt %.

The weight-average molecular weight of the copolymer in the aqueous dispersion obtained, as determined by gel-permeation chromatography, was 20,000 as polystyrene. The glass transition temperature (calculated) of the copolymer in the aqueous dispersion obtained was 60° C. The average particle diameter of the particles dispersed in the aqueous dispersion obtained was 60 nm.

A nail enamel composition was prepared and evaluated hereinafter, in a similar manner to the Example above.

### EXAMPLE 9

Polymerization was initiated in a similar manner to Example 1, except that 265.0 wt parts of ion-exchange water was changed to 276.7 wt parts, and 263.7 wt parts of ion-exchange water to 283.4 wt parts; the internal temperature of reaction container was changed from 60° C. to 70° C.; 6.0 wt parts of the 5% aqueous solution of potassium persulfate to 9.0 wt parts, and 14.7 wt parts of the 1% aqueous solution of sodium metabisulfite to 0 wt part.

Then, the reaction container was kept at an internal temperature of 80° C. for 5 minutes, and the other preemulsion and 14.7 wt parts of the 5% aqueous solution of potassium persulfate were added dropwise over 3 hours, and the mixture was stirred additionally for 3 hours at an internal temperature kept at 80° C. The polymerization reaction solution was kept at a pH of 3.0 during emulsion polymerization. After reaction, the solution was cooled to a temperature of 30° C., and 3.9 wt parts of 25% aqueous ammonia was added thereto; and the mixture was adjusted to a pH of 8.5, to give an aqueous dispersion having a nonvolatile matter concentration of 40.2 wt %.

The weight-average molecular weight of the copolymer in the aqueous dispersion obtained, as determined by gel-permeation chromatography, was 20,000 as polystyrene. The glass transition temperature (calculated) of the copolymer in the aqueous dispersion obtained was 60° C. The average particle diameter of the particles dispersed in the aqueous dispersion obtained was 60 nm.

A nail enamel composition was prepared and evaluated hereinafter, in a similar manner to the Example 1 above.

### EXAMPLE 10

An aqueous nail enamel composition was prepared by mixing 3 wt parts of the pigment dispersion paste obtained in Example 1, 87.5 wt parts of the aqueous dispersion obtained, plasticizers of 4 wt parts of diisopropyl sebacate and 6 wt parts of dipropylene glycol monopropylether, 2 wt parts of mica, and 5 wt parts of ethanol; and the composition was evaluated in a similar manner to Example 1.

### EXAMPLE 11

An aqueous nail enamel composition was prepared by mixing 3 wt parts of the pigment dispersion paste obtained in Example 1, 87.5 wt parts of the aqueous dispersion obtained, plasticizers of 4 wt parts of diisopropyl sebacate and 6 wt parts of dipropylene glycol monopropylether, 2 wt parts of mica, and 1 wt part of bentonite; and the composition was evaluated in a similar manner to Example 1.

### EXAMPLE 12

An aqueous nail enamel composition was prepared by mixing 3 wt parts of the pigment dispersion paste obtained in Example 1, 87.5 wt parts of the aqueous dispersion obtained, plasticizers of 4 wt parts of diisopropyl sebacate and 6 wt parts of dipropylene glycol monopropylether, 2 wt parts of mica, 5 wt parts of ethanol, and 1 wt part of bentonite; and the composition was evaluated in a similar manner to Example 1.

### COMPARATIVE EXAMPLE 1

An aqueous dispersion was prepared in a similar manner to Example 1, except that 265.0 wt parts of ion-exchange water change to 260.0 wt parts, 7.8 wt parts of chain-transfer agent to 0, and 263.7 wt parts of ion-exchange water to 258.7 wt parts. The nonvolatile matter concentration of the aqueous dispersion was 40.6 wt %.

The gel-permeation chromatography of the copolymer in the aqueous dispersion obtained was not performed, because it was insoluble in the measurement solvent tetrahydrofuran. The glass transition temperature (calculated) of the copolymer in the aqueous dispersion obtained was 60° C. The average particle diameter of the particles dispersed in the aqueous dispersion obtained was 60 nm.

A nail enamel composition was prepared and evaluated hereinafter, in a similar manner to the Example above.

### COMPARATIVE EXAMPLE 2

An aqueous dispersion was prepared in a similar manner to Example 1, except that 265.0 wt parts of ion-exchange water was changed to 269.0 wt parts, 7.8 wt parts of 2-ethylhexyl-3-mercaptopropionate to 12.0 wt parts, and 263.7 wt parts of ion-exchange water to 267.2 wt parts. The nonvolatile matter concentration of the aqueous dispersion was 40.0 wt %.

The weight-average molecular weight of the copolymer in the aqueous dispersion obtained, as determined by gel-permeation chromatography, was 5,000 as polystyrene. The glass transition temperature (calculated) of the copolymer in the aqueous dispersion obtained was 60° C. The average particle diameter of the particles dispersed in the aqueous dispersion obtained was 90 nm.

A nail enamel composition was prepared and evaluated hereinafter, in a similar manner to the Example above.

### COMPARATIVE EXAMPLE 3

An aqueous dispersion was prepared in a similar manner to Example 1, except that 7.8 wt parts of 2-ethylhexyl-3-mercaptopropionate used as the mercaptopropionic acid derivative (C) was changed to 5.0 wt parts of dodecylmercaptan. The nonvolatile matter concentration of the aqueous dispersion was 40.5 wt %.

The weight-average molecular weight of the copolymer in the aqueous dispersion obtained, as determined by gel-permeation chromatography, was 20,000 as polystyrene. The glass transition temperature (calculated) of the copolymer in the aqueous dispersion obtained was 60° C. The average particle diameter of the particles dispersed in the aqueous dispersion obtained was 70 nm.

A nail enamel composition was prepared and evaluated hereinafter, in a similar manner to the Example above.

### COMPARATIVE EXAMPLE 4

An aqueous dispersion was prepared in a similar manner to Example 1, except that 7.8 wt parts of 2-ethylhexyl-3-mercaptopropionate used as the mercaptopropionic acid derivative (C) was changed to 0.2 wt parts of dodecylmercaptan. The nonvolatile matter concentration of the aqueous dispersion was 40.5 wt %.

The weight-average molecular weight of the copolymer in the aqueous dispersion obtained, as determined by gel-permeation chromatography, was 70,000 as polystyrene. The glass transition temperature (calculated) of the copolymer in the aqueous dispersion obtained was 60° C. The average particle diameter of the particles dispersed in the aqueous dispersion obtained was 70 nm.

A nail enamel composition was prepared and evaluated hereinafter, in a similar manner to the Example above.

### COMPARATIVE EXAMPLE 5

An aqueous dispersion was prepared in a similar manner to Example 1, except that 39.3 wt parts of tert-butylmethacrylate was change to 0 and 235.6 wt parts of methyl methacrylate to 274.9 wt parts. The nonvolatile matter concentration of the aqueous dispersion was 40.5 wt %.

The weight-average molecular weight of the copolymer in the aqueous dispersion obtained, as determined by gel-permeation chromatography, was 20,000 as polystyrene. The glass transition temperature (calculated) of the copolymer in the aqueous dispersion obtained was 60° C. The average particle diameter of the particles dispersed in the aqueous dispersion obtained was 70 nm.

A nail enamel composition was prepared and evaluated hereinafter, in a similar manner to the Example above.

### COMPARATIVE EXAMPLE 6

An aqueous dispersion was prepared in a similar manner to Example 1, except that 39.3 wt parts of tert-butylmethacrylate was change to 0, 235.6 wt parts of methyl methacrylate to 251.3 wt parts, and 70.7 wt parts of 2-ethylhexyl acrylate to 55.0 wt parts. The nonvolatile matter concentration of the aqueous dispersion was 40.4 wt %.

The weight-average molecular weight of the copolymer in the aqueous dispersion obtained, as determined by gel-permeation chromatography, was 20,000 as polystyrene. The glass transition temperature (calculated) of the copolymer in the aqueous dispersion obtained was 60° C. The average particle diameter of the particles dispersed in the aqueous dispersion obtained was 70 nm.

A nail enamel composition was prepared and evaluated hereinafter, in a similar manner to the Example 1 above.

(Evaluation of Basic Properties)

Film-Forming Method:

The aqueous nail enamel composition prepared in each of the Examples and Comparative Examples above was coated on a base material to a dry film thickness of 120 μm and dried at 25° C. for 3 days, to give a coated film. The film was evaluated by the following methods:

1. Removal Efficiency:

A coated film of each of the aqueous nail enamel compositions formed on a glass plate was rubbed with cosmetic cotton impregnated with a remover of 60 wt % acetone and 40 wt % water, and the number of reciprocal rubbing needed until the coated film is dissolved was determined and ranked according to the following 5-stage criteria. Meanwhile, general removers commercially available contain acetone in an amount of approximately 90 wt %.

5: Very soluble (3 reciprocations or less)

4: Relatively soluble (less than 10 reciprocations)

3: soluble (15 reciprocations or more)

2: Less soluble (25 reciprocations or more)

1: Not soluble (50 reciprocations or more)

2. Hot Water Resistance:

A coated film of each of the aqueous nail enamel compositions formed on a glass plate was immersed in hot water at 40° C. for 30 minutes, and, after the test plate was removed from hot water, the degree of whitening of the coated film was evaluated by visual observation.

5: No whitening of coated film

4: Whitening of coated film, recovering over time (in 15 minutes)

3: Whitening of coated film, recovering over time (in 30 minutes)

2: Whitening of coated film, recovering over time (in 60 minutes)

1: Whitening of coated film, not recovering over time

3. Flex Resistance:

A film of each aqueous nail enamel composition was formed on a nylon film having a thickness of 500 microns, and the period until the coated film causes cracking when the nylon plate left bent was determined.

5: No cracking of coated film for 14 days

4: Cracking of coated film in 7 days

3: Cracking of coated film in 5 days

2: Cracking of coated film in 3 days

1: Cracking of coated film in 1 day

4. Pencil Hardness:

A film of each aqueous nail enamel composition was formed on a glass plate, and the pencil hardness thereof was determined in an environment at 25° C. Pencil hardness indicates the highest hardness of pencil at which hardness the pencil does not damage the coated film.

5. Pencil Hardness in Hot Water:

A film of each aqueous nail enamel composition was formed on a glass plate, and the panel was immersed in hot water at 40° C. for 15 minutes; and the pencil hardness in hot water was determined. Pencil hardness indicates the highest hardness of pencil at which hardness the pencil does not damage the coated film.

6. Freeze-Thaw Resistance:

Fifty g of the nail enamel composition obtained was placed in a sealed 70-ml glass container and stored under 20 cycles in the conditions at −5° C. for 24 hours and at 50° C. for 24 hours, and then, the freeze-thaw resistance of the nail enamel composition was evaluated in five ranks by comparison of the appearances thereof before and after the test.

5: No change

4: Slight partial freezing immediately after cooling at −5° C., but fusion at room temperature. No change in the appearance of composition at room temperature. A standard needed for practical use.

3: Very slight gelation observed.

2: Partially gelation observed.

1: Entire gelation observed.

[Evaluation of Practicality]

The performance of each nail enamel composition was evaluated by 20 professional panelists under the daily living environment. Each panelist applied the nail enamel composition to the normal thickness, and the following items are evaluated in five ranks after 3 days of normal daily life. The results are shown as averages of the ratings by 20 panelists.

1. Durability of Coated Film in Hot Water of Bath Tub

Each panelist took a bath everyday (a total of thrice) during the course of the experiments, and the degree of deterioration was evaluated by comparison of the appearances of the coated film immediately after start and after the test, according to the following criteria. The degree of deterioration in the appearance of coated film was divided in five ranks by visual observation. This evaluation is aimed at integrally evaluating the degree of the damage on coated film and the separation thereof in hot water under a weakly alkaline environment that is encountered in daily life.

5: No deterioration of coated film

4: Very slight deterioration of coated film

3: Slight deterioration of coated film

2: Some deterioration of coated film

1: Significant deterioration of coated film

2. Removal Efficiency:

After the test, the degree of the efficiency in removing the coated film with cosmetic cotton impregnated with a remover of 90 wt % acetone and 10 wt % water was evaluated by each panelist according to the normal method.

5: Very efficient

4: More efficient (lowest standard needed for practical use)

3: Efficient

2: Less efficient

1: Not efficient

3. Stability of Glossiness

The degree of deterioration in glossiness was determined in five ranks, by comparing the glossiness of the coated film immediately after start of testing and that after the test.

5: Almost no deterioration in glossiness

4: Slight deterioration in glossiness

3: Some deterioration in glossiness

2: Significant deterioration in glossiness

1: No glossiness

4. Odor:

The odor of each nail enamel composition was evaluated sensory in five ranks when the nail enamel composition is applied, according to the following criteria:

5: No foul odor

4: Very slight foul odor (lowest standard needed for practical use)

3: Slight foul odor

2: Some foul odor

1: Significant foul odor, prohibiting practical use

5. Appearance Reproducibility

The appearance reproducibility (%) was determined in five ranks by visual observation of the difference in color tone between the nail enamel composition before application and that after application.

5: Almost no difference

4: Very slight difference

3: Slight difference

2: Some difference

1: Significant difference

TABLE 1

| | | Ex. 1 | Ex. 2 | Ex. 3 | Ex. 4 | Ex 5 | Ex. 6 |
|---|---|---|---|---|---|---|---|
| Monomer(A) | | t-BMA | t-BMA | t-BMA | t-BMA | t-BMA | t-BMA |
| | | | | | | | CHMA |
| Chain-transfer agent*1 | | BMPA-2EH | BMPA-MB | BMPA-2EH | BMPA-2EH | BMPA-2EH | BMPA-2EH |
| | | 2.0 wt parts | 1.3 wt parts | 2.0 wt parts | 2.0 wt parts | 2.0 wt parts | 2.0 wt parts |
| Emulsifier | Anionic reactive | AqualonKH-10 | AqualonKH-10 | AqualonKH-10 | AqualonKH-10 | AqualonKH-10 | AqualonKH-10 |
| | Nonionic reactive | | | | Adeka Reasoap | | |
| | | | | | ER-20 | | |

| Tg(° C.) | | | 60 | 60 | 40 | 55 | 65 | 60 |
|---|---|---|---|---|---|---|---|---|
| Mw | | | 20,000 | 30,000 | 23,000 | 20,000 | 20,000 | 20,000 |
| Average particle diameter(nm) | | | 60 | 110 | 70 | 70 | 60 | 60 |
| Evaluation | 1 | Removal efficiency | 5 | 4 | 5 | 5 | 5 | 5 |
| of basic | 2 | Hot water resistance | 5 | 5 | 4 | 5 | 4 | 5 |
| properties | 3 | Flex resistance | 5 | 5 | 5 | 5 | 5 | 5 |
| | 4 | Pencil hardness | 3H | 3H | 2H | 3H | 3H | 3H |
| | 5 | Pencil hardness in hot water | F | F | HB | F | F | H |
| | 6 | Freeze-thaw resistance | 4 | 4 | 4 | 4 | 4 | 4 |
| Evaluation of | 1 | Film durability | 5 | 5 | 4 | 5 | 4 | 5 |
| practicality | 2 | Removal efficiency | 5 | 4 | 5 | 5 | 5 | 5 |
| | 3 | Stability of glossiness | 5 | 5 | 4 | 5 | 4 | 5 |
| | 4 | Odor | 5 | 5 | 5 | 5 | 5 | 5 |
| | 5 | Appearance reproducibility | 5 | 4 | 5 | 4 | 5 | 5 |

TABLE 2

| | | Ex. 7 | Ex. 8 | Ex. 9 | Ex. 10 | Ex. 11 | Ex. 12 |
|---|---|---|---|---|---|---|---|
| Monomer(A) | | BzMA | CHMA | t-BMA | t-BMA | t-BMA | t-BMA |
| Chain transfer agent*1 | | BMPA-2EH | BMPA-2EH | BMPA-2EH | BMPA-2EH | BMPA-2EH | BMPA-2EH |
| | | 2.0 wt parts | 2.0 wt parts | 2.0 wt parts | 2.0 wt parts | 2.0 wt parts | 2.0 wt parts |
| Emulsifier | Anionic reactive | AqualonKH-10 | AqualonKH-10 | AqualonKH-10 | AqualonKH-10 | AqualonKH-10 | AqualonKH-10 |
| | Nonionic reactive | | | | | | |

| Tg(° C.) | | | 60 | 60 | 60 | 60 | 60 | 60 |
|---|---|---|---|---|---|---|---|---|
| Mw | | | 20,000 | 20,000 | 20,000 | 20,000 | 20,000 | 20,000 |
| Average particle diameter (nm) | | | 60 | 60 | 60 | 60 | 60 | 60 |
| Evaluation | 1 | Removal efficiency | 5 | 5 | 5 | 5 | 5 | 5 |
| of basic | 2 | Hot water resistance | 5 | 5 | 5 | 5 | 5 | 5 |
| properties | 3 | Flex resistance | 5 | 5 | 5 | 5 | 5 | 5 |
| | 4 | Pencil hardness | 3H | 3H | 3H | 3H | 3H | 3H |
| | 5 | Pencil hardness in hot water | F | F | F | F | F | F |
| | 6 | Freeze-thaw resistance | 4 | 4 | 4 | 5 | 4 | 5 |
| Evaluation of | 1 | Film durability | 5 | 5 | 5 | 5 | 5 | 5 |
| practicality | 2 | Removal efficiency | 5 | 5 | 5 | 5 | 5 | 5 |
| | 3 | Stability of glossiness | 5 | 5 | 5 | 5 | 5 | 5 |
| | 4 | Odor | 5 | 5 | 5 | 5 | 5 | 5 |
| | 5 | Appearance reproducibility | 5 | 5 | 5 | 5 | 5 | 5 |

TABLE 3

| | | Com Ex. 1 | Com Ex. 2 | Com Ex. 3 | Com Ex. 4 | Com Ex. 5 | Com Ex. 6 |
|---|---|---|---|---|---|---|---|
| Monomer(A) | | t-BMA | t-BMA | t-BMA | t-BMA | | |
| Chain transfer agent *1 | | | BMPA-2EH | DDME | DDME | BMPA-2EH | BMPA-2EH |
| | | | 3.1 wt parts | 1.3 wt parts | 0.05 wt parts | 2.0 wt parts | 2.0 wt parts |
| Emulsifier | Anionic reactive | AqualonKH-10 | AqualonKH-10 | AqualonKH-10 | AqualonKH-10 | AqualonKH-10 | AqualonKH-10 |
| | Nonionic reactive | | | | | | |

| Tg(° C.) | | | 60 | 60 | 60 | 60 | 60 | 60 |
|---|---|---|---|---|---|---|---|---|
| Mw | | | — | 5,000 | 20,000 | 70,000 | 20,000 | 20,000 |
| Average particle diameter (nm) | | | 60 | 90 | 70 | 70 | 70 | 70 |
| Evaluation | 1 | Removal efficiency | 1 | 5 | 5 | 1 | 5 | 5 |
| of basic | 2 | Hot water resistance | 5 | 3 | 5 | 5 | 2 | 2 |
| properties | 3 | Flex resistance | 5 | 5 | 5 | 5 | 5 | 5 |
| | 4 | Pencil hardness | 3H | HB | 3H | 3H | 3H | 3H |
| | 5 | Pencil hardness in hot water | F | 6B | F | F | 5B | 4B |
| | 6 | Freeze-thaw resistance | 2 | 4 | 2 | 2 | 4 | 4 |
| Evaluation of | 1 | Film durability | 5 | 2 | 5 | 5 | 1 | 1 |
| practicality | 2 | Removal efficiency | 1 | 5 | 5 | 1 | 5 | 5 |
| | 3 | Stability of glossiness | 5 | 2 | 5 | 5 | 1 | 1 |
| | 4 | Odor | 5 | 5 | 1 | 4 | 5 | 5 |
| | 5 | Appearance reproducibility | 5 | 5 | 3 | 3 | 5 | 5 |

*1: An amount of chain-transfer with respect to 100 wt parts of total monomers

t-BMA: tert-butyl methacrylate

BzMA: benzyl methacrylate

n-BMA: n-butyl methacrylate

CHMA: cyclohexyl methacrylate

BMPA-2-EH: 2-ethylhexyl 3-mercaptopropionate

BMPA-MB: methoxybutyl mercaptopropionate

DDME: dodecylmercaptan

As apparent from Tables 1 and 2, the aqueous nail enamel compositions prepared in Examples are superior in removal efficiency and other properties.

On the other hand, as shown in Table 3, the aqueous nail enamel compositions prepared in Comparative Examples can not satisfy all of the basic properties and other properties such as removal efficiency, odor, appearance reproducibility, stability of glossiness, durability of coated film in hot water of bath tub, and others in the balanced manner. Thus, these aqueous nail enamel compositions are unsatisfactory for practical use.

Although favorable embodiments of the present invention have been described so far, it should be understood for those in the art that various modifications and alternatives are possible within the spirit of scope of the present invention.

1. An aqueous dispersion for nail enamel, comprising a copolymer (E) having a weight-average molecular weight, as determined by gel-permeation chromatography, of 10,000 or more and 40,000 or less as polystyrene, the copolymer (E) is obtainable by polymerizing a total of 100 wt parts of a monomer (A) selected from the group consisting of tert-butyl(meth)acrylate, cyclohexyl(meth)acrylate and benzyl(meth)acrylate and a radical-polymerization unsaturated monomer (B) other than the monomer (A) in an aqueous medium in the presence of 0.1 to 10.0 wt parts of a mercaptopropionic acid derivative (C) represented by the following General Formula (1):
(HS—CH₂—CH₂—COO)ₙ—R General Formula (1)
wherein, n is an integer of 1 to 4; and R represents an alkyl group having 4 or more carbon atoms or an alkoxyalkyl group having 4 or more carbon atoms when n is 1 and an n-valent organic residue when n is 2 to 4.

2. The aqueous dispersion for nail enamel according to claim 1, which is obtainable by emulsion polymerization by using an anionic emulsifier (F) having one or more unsaturated radical-polymerization groups.

3. The aqueous dispersion for nail enamel according to claim 1, wherein the monomer (A) is contained in an amount of 1 to 50 wt % with respect to a total of 100 wt % of the monomer (A) and the radical-polymerization unsaturated monomer (B) other than the monomer (A).

4. The aqueous dispersion for nail enamel according to any one of claim 1, wherein the glass transition temperature (Tg) of the copolymer (E) is 50 to 80° C.

5. The aqueous dispersion for nail enamel according to any one of claim 1, wherein the mercaptopropionic acid derivative (C) is octyl mercaptopropionate.

6. The aqueous dispersion for nail enamel according to any one of claim 1, wherein the average particle diameter of the copolymer (E) is 30 to 100 nm.

7. A method of producing an aqueous dispersion for nail enamel comprising a copolymer (E) having a weight-average molecular weight, as determined by gel-permeation chromatography, of 10,000 or more and 40,000 or less as polystyrene, which comprises: polymerizing a total of 100 wt parts of a monomer (A) selected from the group consisting of tert-butyl(meth)acrylate, cyclohexyl(meth)acrylate and benzyl(meth)acrylate and a radical-polymerization unsaturated monomer (B) other than the monomer (A) in an aqueous medium in the presence of 0.1 to 10.0 wt parts of a mercaptopropionic acid derivative (C) represented by the following General Formula (1):
(HS—CH₂—CH₂—COO)ₙ—R, General Formula (1)
wherein R represents an alkyl group having 4 or more carbon atoms or an alkoxyalkyl group having 4 or more carbon atoms when n is 1 and an n-valent organic residue when n is 2 to 4.

8. An aqueous nail enamel composition, comprising a copolymer (E) in an amount of 10 to 60 wt %,
wherein the copolymer (E) has a weight-average molecular weight of 10,000 or more and 40,000 or less as polystyrene, the copolymer (E) is obtainable by polymerizing a total of 100 wt parts of a monomper (A) selected from the group consisting of tert-butyl (meth)acrylate, cyclohexyl(meth)acrylate and benzyl(meth)acrylate and a radical-polymerization unsaturated monomer (B) other than the monomer (A) in an aqueous medium in the presence of 0.1 to 10.0 wt parts of a mercaptopropionic acid derivative (C) represented by the following General Formula (1):
(HS—CH₂—CH₂—COO)—R General Formula (1)
wherein, n is an integer of 1 to 4; and R represents an alkyl group having 4 or more carbon atoms or an alkoxyalkyl group having 4 or more carbon atoms when n is 1 and an n-valent organic residue when n is 2 to 4.

9. The aqueous nail enamel composition according to claim 8, further comprising a lower alcohol having a boiling point of lower than 100° C. in an amount of 0.5 to 15 wt %.

10. An aqueous dispersion for nail enamel, comprising a copolymer (E) dispersed in an aqueous medium, the copolymer (E) having a weight-average molecular weight of 10,000 or more and 40,000 or less, formed from a monomer (A) selected from the group consisting of tert-butyl(meth)acrylate, cyclohexyl(meth)acrylate and benzyl (meth)acrylate and a radical-polymerization unsaturated monomer (B) other than the monomer (A) as the constituent units, and having a mercaptopropionic acid derivative represented by the following Formula (I) at the terminal thereof:
(HS—CH₂—CH₂—COO)ₙ—R, General Formula (1)
wherein R represents an alkyl group having 4 or more carbon atoms or an alkoxyalkyl group having 4 or more carbon atoms when n is 1 and an n-valent organic residue when n is 2 to 4.
